(19) United States
(12) Patent Application Publication
(10) Pub. No.: US 2024/0379283 A1
(43) Pub. Date: Nov. 14, 2024

(54) MULTILAYER INDUCTOR

(71) Applicant: SAMSUNG ELECTRO-MECHANICS CO., LTD., Suwon-si (KR)

(72) Inventors: Juhwan Yang, Suwon-si (KR); Jae-Hun Kim, Suwon-si (KR); Byeongcheol Moon, Suwon-si (KR); Yeji Jung, Suwon-si (KR); Inyoung Kang, Suwon-si (KR); Boumseock Kim, Suwon-si (KR)

(73) Assignee: SAMSUNG ELECTRO-MECHANICS CO., LTD., Suwon-si (KR)

(21) Appl. No.: 18/609,979

(22) Filed: Mar. 19, 2024

(30) Foreign Application Priority Data
May 9, 2023 (KR) 10-2023-0059741

(51) Int. Cl. H01F 27/29; H01F 27/255; H01F 27/28

(52) U.S. Cl. CPC H01F 27/29; H01F 27/255; H01F 2027/2809

(57) ABSTRACT

A multilayer inductor may include: a main body that has a first surface and a second surface facing each other in a first direction, a third surface and a fourth surface connecting the first surface and the second surface and facing each other in a second direction, and including a magnetic material; a plurality of internal electrodes disposed inside the main body; and side surface cover layers that respectively covers the third surface and the fourth surface of the main body. At least one internal electrode of the plurality of internal electrodes may include a first electrode surface and a second electrode surface facing each other in the third direction and a third electrode surface connecting the first electrode surface and the second electrode surface and parallel to the third surface, the fourth surface, or both, and the third electrode surface may contact the side surface cover layer.

### CROSS-REFERENCE TO RELATED APPLICATION

This application claims priority to and the benefit of Korean Patent Application No. 10-2023-0059741 filed at the Korean Intellectual Property Office on May 9, 2023, the entire contents of which are incorporated herein by reference.

### BACKGROUND

### Technical Field

The present disclosure relates to a multilayer inductor.

### Description of the Related Art

As functions of a mobile device have recently diversified, power consumption has increased. Thus, a passive component with low loss and excellent efficiency is employed around a power management integrated circuit (PMIC) to increase a battery usage time of the mobile device. On the other hand, in order to slim a product and increase a degree of freedom in component disposition, a demand for a low-profile power inductor is increasing.

Power inductors may be broadly categorized into multilayer, thin-film, and wire-wound types based on their structure and manufacturing method. The multilayer inductor is manufactured by respectively printing metal patterns on a plurality of sheets made of a magnetic material or a dielectric material having a low dielectric constant and then stacking the plurality of sheets while connecting the metal patterns to each other to form a coil.

The coil formed by printing the metal pattern may have a shape with a sharp edge of a cross-section of the coil so that a magnetic path area is reduced. Since the shape of the cross-section of the coil is sharp so that an alignment tolerance between layers occurs, there are risks of frequency characteristic deterioration and inductance variation due to parasitic capacitance.

### SUMMARY

One aspect of an embodiment is to provide a multilayer inductor that improves a cross-section structure of a coil formed by a printing method.

However, problems to be solved by embodiments of the present disclosure are not limited to the above-described problem and may be variously extended in a range of a technical idea included in the present disclosure.

A multilayer inductor according to an embodiment may include: a main body including a magnetic material, the main body has a first surface and a second surface facing each other in a first direction, a third surface and a fourth surface facing each other in a second direction and connecting the first surface and the second surface, and a fifth surface and a sixth surface facing each other in a third direction and connecting the first surface and the second surface; a plurality of internal electrodes disposed inside the main body; an outer electrode disposed outside the main body; and side surface cover layers that respectively covers the third surface and the fourth surface. At least one internal electrode among the plurality of internal electrodes may include a first electrode surface and a second electrode surface facing each other in the third direction and a third electrode surface connecting the first electrode surface and the second electrode surface and substantially parallel to the third surface, the fourth surface, or both, and the third electrode surface may contact the side surface cover layers.

In addition, the at least one internal electrode may include two edges opposing each other in the second direction, and the two edges include (i) one edge comprising the third electrode surface, and (ii) an other edge.

In addition, the at least one internal electrode may have a tapered shape toward the one edge.

In addition, the first electrode surface and the second electrode surface may meet to make an acute angle at the other edge.

In addition, the at least one internal electrode may have a tapered shape toward the other edge.

In addition, the at least one internal electrode may have a width that is a distance between the two edges, and a first thickness that is an average value of distances between the first electrode surface and the second electrode surface measured over a range corresponding to 60% of the width, the third electrode surface may have a second thickness along the third direction, and a ratio of the second thickness to the first thickness may be greater than 0 and less than or equal to 1.

In addition, a ratio of the second thickness to the first thickness may be greater than 0 and less than or equal to 0.75.

In addition, a ratio of the second thickness to the first thickness may be greater than 0 and less than or equal to 0.48.

In addition, the third electrode surface may be flush with the third surface or be flush with the fourth surface.

In addition, in a cross-section perpendicular to the first direction, a thickness of each of the side surface cover layers along the second direction may be 10 μm or more and 30 μm or less.

In addition, the main body and each of the side surface cover layers may include the same material.

In addition, the main body and each of the side surface cover layers may include different materials.

In addition, each of the side surface cover layers may include a first cover layer that is in contact with the third electrode surface and a second cover layer that covers the first cover layer, the first cover layer may include a material different from that of the main body, and the second cover layer may include the same material as the main body.

In addition, the first cover layer may include a first magnetic particle, the main body may include a second magnetic particle, and a particle diameter of the first magnetic particle may be 5% or more and 30% or less of a particle diameter of the second magnetic particle.

In addition, the outer electrode may be connected to the plurality of internal electrodes on the first surface and/or the second surface, may extend to the fifth surface and the sixth surface, and may cover two edges of each of the side surface cover layers facing each other in the first direction.

In addition, the outer electrode may be connected to the plurality of internal electrodes on the first surface and/or the second surface and may extend to the fifth surface and the sixth surface, and each of the side surface cover layers may contact the outer electrode (i) at a boundary between the third surface and the first surface, the second surface, the fifth surface, and the sixth surface and (ii) at a boundary between the fourth surface and the first surface, the second surface, the fifth surface, and the sixth surface.

In addition, the outer electrode may be connected to the plurality of internal electrodes on the fifth surface or the sixth surface, the outer electrode may cover a portion of the fifth surface or the sixth surface, and each of the side surface cover layers may cover the first surface, the second surface, the third surface, and the fourth surface.

A multilayer inductor according to an embodiment may include: a main body including a magnetic material, the main body has a first surface and a second surface facing each other in a first direction, a third surface and a fourth surface facing each other in a second direction and connecting the first surface and the second surface, and a fifth surface and a sixth surface facing each other in a third direction and connecting the first surface and the second surface; a plurality of internal electrodes disposed inside the main body; an outer electrode disposed outside the main body; and side surface cover layers that respectively covers the third surface and the fourth surface. At least one internal electrode among the plurality of internal electrodes may include a first electrode surface and a second electrode surface facing each other in the third direction and a third electrode surface connecting the first electrode surface and the second electrode surface and substantially parallel to the third surface, the fourth surface, or both, and the third electrode surface may contact the side surface cover layers. The at least one internal electrode may include two edges opposing each other in the second direction, and the at least one internal electrode may have a shape that tapers toward each of the two edges.

In addition, in a cross-section perpendicular to the first direction, a thickness of each of the side surface cover layers along the second direction may be 10 μm or more and 30 μm or less.

In addition, the at least one internal electrode may have a width that is a distance between the two edges, and a first thickness that is an average value of distances between the first electrode surface and the second electrode surface measured over a range corresponding to 60% of the width, the third electrode surface may have a second thickness along the third direction, and a ratio of the second thickness to the first thickness may be greater than 0 and less than 1.

According to a multilayer inductor according to the embodiment, a flat surface may be formed at an edge of a cross-section of a coil formed by a printing method so that a magnetic path is prevented from being reduced and DC resistance variation and inductance variation are prevented from occurring.

### BRIEF DESCRIPTION OF THE DRAWINGS

FIG. 1 is a perspective view schematically showing a multilayer inductor according to an embodiment.

FIG. 2 is a perspective view schematically illustrating the multilayer inductor shown in FIG. 1 with outer electrodes removed.

FIG. 3 is a perspective view schematically illustrating the multilayer inductor shown in FIG. 2 with side surface cover layers removed.

FIG. 4 is a cross-sectional view taken along line IV-IV′ in FIG. 2.

FIG. 5 is a partially enlarged view schematically illustrating a side electrode of the multilayer inductor shown in FIG. 4.

FIG. 6 is an exploded perspective view schematically illustrating the multilayer inductor shown in FIG. 3.

FIG. 7 is a plan view schematically illustrating the arrangement of internal electrodes and side surface cover layers of the multilayer inductor shown in FIG. 1.

FIG. 8 is a perspective view schematically showing a multilayer inductor according to another embodiment.

FIG. 9 is a plan view schematically illustrating the arrangement of internal electrodes and side surface cover layers of the multilayer inductor shown in FIG. 8.

FIG. 10 is a perspective view schematically showing a multilayer inductor according to yet another embodiment.

FIG. 11 is a plan view schematically illustrating the arrangement of internal electrodes and side surface cover layers of the multilayer inductor shown in FIG. 10.

### DETAILED DESCRIPTION

Hereinafter, various embodiment of the present disclosure will be described in detail so that a person of ordinary skill in the technical field to which the present disclosure belongs can easily implement it with reference to the accompanying drawings. In order to clearly describe the present disclosure, parts or portions that are irrelevant to the description are omitted in the drawings, and identical or similar constituent elements throughout the specification are denoted by the same reference numerals. In addition, some constituent elements in the accompanying drawings are exaggerated, omitted, or schematically illustrated, and the size of each constituent element does not fully reflect the actual size.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various components, and are not to be interpreted as limiting these components. The terms are only used to differentiate one component from other components.

It will be understood that when an element such as a layer, film, region, area, or substrate is referred to as being “on” or “above” another element, it may be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

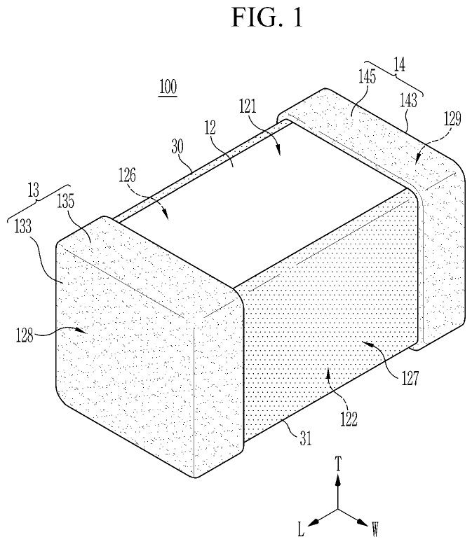

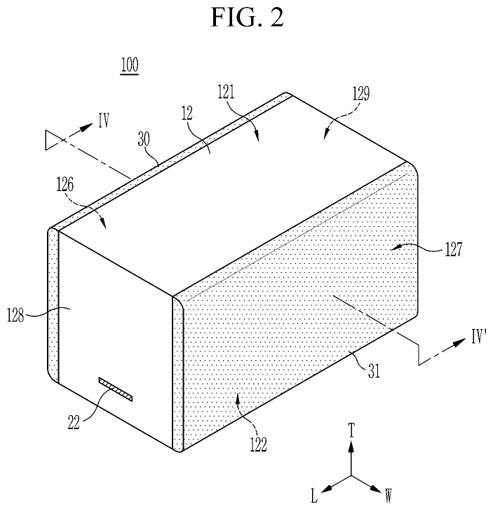

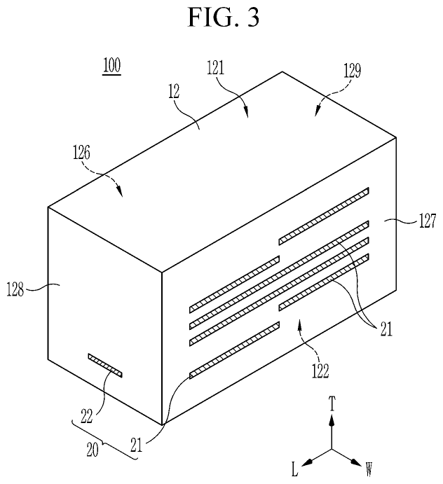

FIG. 1 is a perspective view schematically showing a multilayer inductor according to an embodiment, FIG. 2 is a perspective view schematically illustrating the multilayer inductor shown in FIG. 1 with outer electrodes removed, and FIG. 3 is a perspective view schematically illustrating the multilayer inductor shown in FIG. 2 with side surface cover layers removed.

Referring to FIG. 1, FIG. 2, and FIG. 3, the multilayer inductor 100 according to the present embodiment includes a main body 12, a plurality of internal electrodes 20, a first outer electrode 13, a second outer electrode 14, a first side surface cover layer 30, and a second side surface cover layer 31.

The main body 12 may include a magnetic material, and may be made of magnetic particles and a thermosetting resin such as epoxy, polyimide, or the like interposed between the magnetic particles.

The magnetic particle may be a ferrite particle or a metallic magnetic particle that exhibit magnetic properties.

For example, the ferrite particle may include at least one or more of a spinel type ferrite such as Mg—Zn based, Mn—Zn based, Mn—Mg based, Cu—Zn based, Mg—Mn—Sr based, Ni—Zn based, or the like, a hexagonal type ferrite such as Ba—Zn based, Ba—Mg based, Ba—Ni based, Ba—Co based, Ba—Ni—Co based, or the like, a garnet type ferrite such as Y-based or the like, and Li-based ferrite.

The metallic magnetic particle may include one or more selected from the group consisting of iron (Fe), silicon (Si), chromium (Cr), aluminum (Al), and nickel (Ni). For example, the metallic magnetic particle may include at least one or more of pure iron, Fe—Si based alloy, Fe—Si—Al based alloy, Fe—Ni based alloy, Fe—Ni—Mo based alloy, Fe—Ni—Mo—Cu based alloy, Fe—Co based alloy, Fe—Ni—Co based alloy, Fe—Cr based alloy, Fe—Cr—Si based alloy, Fe—Si—Cu—Nb based alloy, Fe—Ni—Cr based alloy, and Fe—Cr—Al based alloy.

The metallic magnetic particle may be amorphous or crystalline. For example, the metallic magnetic particle may be Fe—Si—B—Cr based amorphous alloy, but the present embodiment is not limited thereto.

Each of the ferrite particle and the metallic magnetic particle may have an average diameter of about 0.1 μm to about 30 μm, but the present embodiment is not limited thereto. In the present specification, a particle diameter or an average diameter may mean a particle size distribution expressed as D₉₀, D₅₀, or the like.

The metallic magnetic particles may be two or more types of different metallic magnetic particles. Here, by different types of metallic magnetic particles, it means that the metallic magnetic particles are distinguished from each other in at least one of an average diameter, a composition, a composition ratio, crystallinity, and a shape.

An insulating resin may include epoxy, polyimide, a liquid crystal polymer, or a mixture thereof, but the present disclosure is not limited thereto.

The main body 12 may have an approximately hexahedral shape, but the present embodiment is not limited thereto. Due to contraction of a magnetic powder or the like during sintering, the main body 12 may not have a perfect hexahedral shape, but may have a substantially hexahedral shape. For example, the main body 12 may have an approximately rectangular parallelepiped shape, but a portion corresponding to a corner or a vertex of the rectangular parallelepiped may have a round shape.

Defining orientation to clearly illustrate the present embodiment, L, W, and T shown in the drawings refer to axes representing a length direction (e.g., first direction), a width direction (e.g., a second direction), and a thickness direction (e.g., a third direction) of the multilayer inductor 100, respectively.

The thickness direction (T-axis direction) may be a direction perpendicular to wide surfaces of components having a sheet shape. For example, the thickness direction (T-axis direction) may be a direction in which the internal electrodes 20 are stacked.

The length direction (L-axis direction) may be a direction parallel to the wide surfaces of the components having a sheet shape, and may be a direction that intersects (or is orthogonal to) the thickness direction (T-axis direction). For example, the length direction (L-axis direction) may be a direction in which the first outer electrode 13 and the second outer electrode 14 face each other.

The width direction (a W-axis direction) may be a direction parallel to the wide surfaces of the components having a sheet shape, and may intersect (or is orthogonal to) the thickness direction (T-axis direction) and the length direction (L-axis direction) at the same time.

In the present embodiment, for convenience of explanation, two surfaces facing each other in the thickness direction (T-axis direction; third direction) are defined as an upper surface 121 (e.g., fifth surface) and a lower surface 122 (e.g., sixth surface), two surfaces facing each other in the length direction (L-axis direction; first direction) are defined as a first end surface 128 (e.g., first surface) and a second end surface 129 (e.g., second surface), and two surfaces facing each other in the width direction (W-axis direction; second direction) are defined as a first side surface 126 (e.g., third surface) and a second side surface 127 (e.g., fourth surface).

A length of the multilayer inductor 100 is measured on the basis of an optical microscope or scanning electron microscope (SEM) image of a cross-section taken in the length direction (L-axis direction)—the thickness direction (T-axis direction) at a central portion of the width direction (W-axis direction) of the multilayer inductor 100. The length of the multilayer inductor 100 may be a maximum value among lengths of a plurality of line segments that connect two outermost boundary lines facing each other in the length direction (L-axis direction) of a multilayer inductor 100 shown in the cross-sectional image and are parallel to the length direction (L-axis direction). Alternatively, the length of the multilayer inductor 100 may be a minimum value among the lengths of the plurality of line segments that connect the two outermost boundary lines facing each other in the length direction (L-axis direction) of the multilayer inductor 100 shown in the cross-sectional image and are parallel to the length direction (L-axis direction). Alternatively, the length of the multilayer inductor 100 may be an arithmetic mean value of lengths of at least two line segments among the plurality of line segments that connect the two outermost boundary lines facing each other in the length direction (L-axis direction) of the multilayer inductor 100 shown in the cross-section image and are parallel to the length direction (L-axis direction).

A thickness of the multilayer inductor 100 is measured on the basis of an optical microscope or scanning electron microscope (SEM) image of the cross-section taken in the length direction (L-axis direction)—the thickness direction (T-axis direction) at the central portion of the width direction (W-axis direction) of the multilayer inductor 100. The thickness of the multilayer inductor 100 may be a maximum value among lengths of a plurality of line segments that connect two outermost boundary lines facing each other in the thickness direction (T-axis direction) of the multilayer inductor 100 shown in the cross-sectional image and are parallel to the thickness direction (T-axis direction). Alternatively, the thickness of the multilayer inductor 100 may be a minimum value among the lengths of the plurality of line segments that connect the two outermost boundary lines facing each other in the thickness direction (T-axis direction) of the multilayer inductor 100 shown in the cross-sectional image and are parallel to the thickness direction (T-axis direction). Alternatively, the thickness of the multilayer inductor 100 may be an arithmetic mean value of lengths of at least two line segments among the plurality of line segments that connect the two outermost boundary lines facing each other in the thickness direction (T-axis direction) of the multilayer inductor 100 shown in the cross-section image and are parallel to the thickness direction (T-axis direction).

A width of the multilayer inductor 100 is measured on the basis of an optical microscope or scanning electron microscope (SEM) image of a cross-section taken in the length direction (L-axis direction)—the width direction (W-axis direction) at a central portion of the thickness direction (T-axis direction) of the multilayer inductor 100. The width of the multilayer inductor 100 may be a maximum value among lengths of a plurality of line segments that connect two outermost boundary lines facing each other in the width direction (W-axis direction) of the multilayer inductor 100 shown in the cross-sectional image and are parallel to the width direction (W-axis direction). Alternatively, the width of the multilayer inductor 100 may be a minimum value among the lengths of the plurality of line segments that connect the two outermost boundary lines facing each other in the width direction (W-axis direction) of the multilayer inductor 100 shown in the cross-sectional image and are parallel to the width direction (W-axis direction). Alternatively, the width of the multilayer inductor 100 may be an arithmetic mean value of lengths of at least two line segments among the plurality of line segments that connect the two outermost boundary lines facing each other in the width direction (W-axis direction) of the multilayer inductor 100 shown in the cross-sectional image and are parallel to the width direction (W-axis direction).

Meanwhile, each of the length, the width, and the thickness of the multilayer inductor 100 may be measured by a micrometer measurement method. In the micrometer measurement method, a zero point may be set with a micrometer providing repeatability and reproducibility (Gage R&R), the multilayer inductor 100 according to the present embodiment may be inserted between tips of the micrometer, and a measuring lever of the micrometer is turned for the measurement. Meanwhile, when measuring the length of the multilayer inductor 100 by the micrometer measurement method, the length of the multilayer inductor 100 may mean a single measured value or may mean an arithmetic average of a plurality of measured values. This may be equally applied to measuring the width and the thickness of the multilayer inductor 100.

The plurality of internal electrodes 20 are stacked in the thickness direction (T-axis direction) inside the main body 12, and includes side electrodes 21 and lead portions 22.

The side electrode 21 is a portion of the internal electrode 20, and refers to a portion of a region including an exposed portion of the internal electrode 20 in contact with the first side surface 126 or the second side surface 127 of the main body 12.

The lead portions 22 and 22 are portions where the internal electrodes 20 are electrically connected to the first outer electrode 13 and the second outer electrode 14. In a coil structure in which the plurality of internal electrodes 20 are connected to each other, the lead portions 22 may be provided at both ends of the coil. The lead portions 22 and 22 are portions exposed from the first end surface 128 and the second end surface 129 of the main body 12.

The first outer electrode 13 and the second outer electrode 14 are disposed outside the main body 12 and are connected to the internal electrodes 20. That is, the first outer electrode 13 and the second outer electrode 14 are respectively connected to the lead portions 22 and 22 of the internal electrodes 20.

Each of the first outer electrode 13 and the second outer electrode 14 may be made by a conductive paste containing a conductive metal. For example, each of the first and second outer electrodes 13 and 14 may be formed by dipping the main body into the conductive paste. The conductive metal may include nickel (Ni), copper (Cu), palladium (Pd), gold (Au), or an alloy thereof, but the present disclosure is not limited thereto.

The first outer electrode 13 is connected to the lead portion 22 of the internal electrode 20 at the first end surface 128 of the main body 12, and extends to the upper surface 121, the lower surface 122, the first side surface 126, and the second side surface 127.

The second outer electrode 14 is connected to the lead portion 22 of the internal electrode 20 at the second end surface 129 of the main body 12, and extends to the upper surface 121, the lower surface 122, the first side surface 126, and the second side surface 127.

For example, the first and second outer electrodes 13 and 14 may be disposed at both end portions of the length direction (L-axis direction) of the main body 12, the first outer electrode 13 may include a first end portion 133 and a first band portion 135, and the second outer electrode 14 may include a second end portion 143 and a second band portion 145.

The first end portion 133 covers the first end surface 128 of the main body 12, and is electrically connected to the lead portion 22 of the internal electrode 20.

The second end portion 143 covers the second end surface 129 of the main body 12, and is electrically connected to the lead portion 22 of the internal electrode 20.

The first band portion 135 may extend from the first end portion 133 along the length direction (L-axis direction) of the main body 12, and may cover a portion of the upper surface 121 and a portion of the lower surface 122 of the main body 12, a portion of the first side surface cover layer 30, and a portion of the second side surface cover layer 31. That is, a portion of the first side surface cover layer 30 on the first side surface 126 and a portion of the second side surface cover layer 31 and the second side surface 127 of the main body 12 may be covered by the first band portion 135.

The second band portion 145 may extend from the second end portion 143 along the length direction (L-axis direction) of the main body 12, and may cover a portion of the upper surface 121 and a portion of the lower surface 122 of the main body 12, a portion of the first side surface cover layer 30, and a portion of the second side surface cover layer 31. That is, a portion of the first side surface cover layer 30 on the first side surface 126 and a portion of the second side surface cover layer 31 and the second side surface 127 of the main body 12 may be covered by the second band portion 145.

Each of the first and second outer electrodes 13 and 14 may be made of a conductive material such as copper (Cu), aluminum (Al), silver (Ag), tin (Sn), gold (Au), nickel (Ni), lead (Pb), chromium (Cr), titanium (Ti), an alloy thereof, or the like, but the present disclosure is not limited thereto.

The first and second outer electrodes 13 and 14 may each include a plurality of electrode layers. For example, each of the first and second outer electrodes 13 and 14 may include a first electrode layer, a second electrode layer that covers the first electrode layer, and a third electrode layer that covers the second electrode layer. The first electrode layer may include copper (Cu), and may be a conductive resin layer. The conductive resin layer may include a conductive metal for securing electrical conductivity and a resin for shock absorption. The resin is not particularly limited as long as it may have bondability and shock absorption properties and may be mixed with conductive metal powder to form a paste. For example, the resin may include a phenol resin, an acrylic resin, a silicone resin, an epoxy resin, or a polyimide resin. The conductive metal may include, for example, copper (Cu), tin (Sn), nickel (Ni), silver (Ag), palladium (Pd), gold (Au), platinum (Pt), tungsten (W), titanium (Ti), an alloy thereof, or combinations thereof.

The first and second outer electrodes 13 and 14 may each include nickel (Ni), copper (Cu), palladium (Pd), gold (Au), or an alloy thereof, and may each include a plurality of layers. For example, the first and second outer electrodes 13 and 14 may each be a combination of a nickel (Ni) layer, a copper (Cu) layer, a nickel/copper (Ni/Cu) layer, a palladium/nickel (Pd/Ni) layer, a palladium/nickel/copper (Pd/Ni/Cu) layer, and a copper/nickel/copper (Cu/Ni/Cu) layer.

In some embodiments, an outermost layer of each of the first and second outer electrodes 13 and 14 may include tin (Sn). Since the tin plating layer has a relatively low melting point, it is possible to improve ease of mounting the first and second outer electrodes 13 and 14 on a substrate.

In general, the tin plating layer may be coupled to an electrode pad on the substrate through solder including a tin (Sn)—copper (Cu)—silver (Ag) alloy paste. That is, the tin plating layer may melt and bond with the solder during a reflow process.

The first side surface cover layer 30 and the second side surface cover layer 31 respectively cover the first side surface 126 and the second side surface 127 of the main body 12. That is, the first side surface cover layer 30 covers the first side surface 126 of the main body 12, and the second side surface cover layer 31 covers the second side surface 127 of the main body 12.

Meanwhile, a portion of the side electrode 21 may be exposed from the first side surface 126 or may be exposed from the second side surface 127 depending on the position of the side electrode 21. The portion exposed from the first side surface 126 may be covered by the first side surface cover layer 30 and the portion exposed from the second side surface 127 may be covered by the second side surface cover layer 31. In other words, the exposed portion of the side electrode 21 may be in contact with the first side surface cover layer 30 or the second side surface cover layer 31. The first and second side surface cover layers 30 and 31 may prevent a conductive foreign substance from entering the side electrode 21 so that reliability of the multilayer inductor 100 is improved.

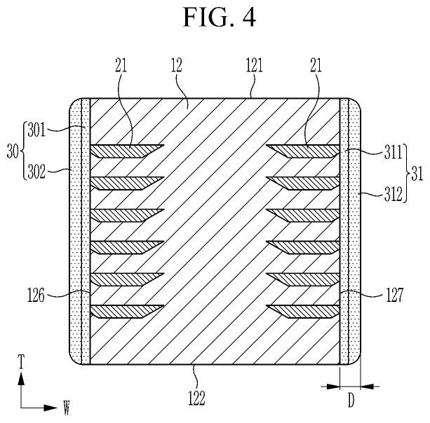

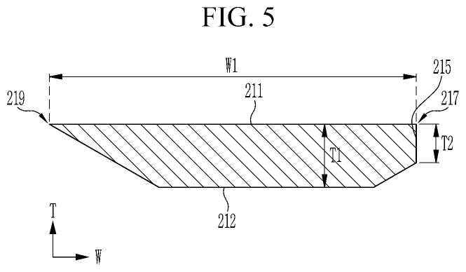

Hereinafter, a structure of the internal electrode 20 of the multilayer inductor 100 will be described in more detail with reference to FIGS. 4 and 5.

FIG. 4 is a cross-sectional view taken along line IV-IV′ in. 2, and shows a cross-section taken in the width direction (W-axis direction)—the thickness direction (T-axis direction), and FIG. 5 is a partially enlarged view schematically illustrating a side electrode of the multilayer inductor shown in FIG. 4.

Referring to FIGS. 4 and 5, each side electrode 21 may include a first electrode surface 211, a second electrode surface 212, and a third electrode surface 215.

The first electrode surface 211 and the second electrode surface 212 may face each other in the thickness direction (T-axis direction). The third electrode surface 215 may connect the first electrode surface 211 and the second electrode surface 212, and may be substantially parallel to the first side surface 126, the second side surface 127, or both. As used herein, “substantially parallel” is to be construed as the third electrode surface 215 being parallel to the first side surface 126, the second side surface 127, or that the third electrode surface 215 deviates from the parallelism by a tolerance range acceptable to one of ordinary skill in the art.

Each side electrode 21 may include a first edge 217 and a second edge 219 facing each other in the width direction (W-axis direction). That is, the first edge 217 and the second edge 219 may exist at both ends of the width direction (W-axis direction) of the side electrode 21.

The first edge 217 may comprise the third electrode surface 215, and the side electrode 21 may have a tapered shape toward the first edge 217. For example, a distance between the first electrode surface 211 and the second electrode surface 212 may decrease as the first electrode surface 211 and the second electrode surface 212 get closer to the first edge 217.

The second edge 219 may be a portion where the first electrode surface 211 and the second electrode surface 212 meet to make an acute angle, and the side electrode 21 may have a tapered shape toward the second edge 219. For example, a distance between the first electrode surface 211 and the second electrode surface 212 may decrease as the first electrode surface 211 and the second electrode surface 212 get closer toward the second edge 219.

Each side electrode 21 may have a width W1, which is a distance between the first edge 217 and the second edge 219, and may have a first thickness T1, which is an average value of distances between the first electrode surface 211 and the second electrode surface 212 measured over a range corresponding to 60% of the width W1. For example, referring to FIG. 5, after the distances between the first electrode surface 211 and the second electrode surface 212 are measured at 10 equally spaced points within a range excluding a range corresponding to 20% of the width W1 of the side electrode 21 from left and right sides of the side electrode 21, a first thickness T1 may be obtained by taking an arithmetic mean value of the measured distances.

The third electrode surface 215 may have a second thickness T2. The second thickness T2 may be a distance between both end portions of the third electrode surface 215 along the thickness direction (T-axis direction).

A ratio of the second thickness T2 to the first thickness T1 may be greater than 0 and less than or equal to 1. Furthermore, the ratio of the second thickness T2 to the first thickness T1 may be greater than 0 and less than or equal to 0.75. Furthermore, the ratio of the second thickness T2 to the first thickness T1 may be greater than 0 and less than or equal to 0.48.

As the ratio of the second thickness T2 to first thickness T1 approaches 1, a shape of the side electrode 21 may be closer to a rectangle. That is, a tapered portion of the third electrode surface 215 may be flattened.

The acute angle, first thickness T1, and second thickness T2 may be measured using an optical microscope or a scanning electron microscope (SEM). Other methods and/or tools appreciated by one of ordinary skill in the art, even if not described in the present disclosure, may also be used.

The third electrode surface 215 may comprise the same surface as the first side surface 126 of the main body 12 or the same surface as the second side surface 127 of the main body 12 depending on the position of the third electrode surface 215. That is, the third electrode surface 215 of the side electrode 21 on the left side of FIG. 4 may comprise the same surface as the first side surface 126, and the third electrode surface 215 of the side electrode 21 on the right side of FIG. 4 may comprise the same surface as the second side surface 127. Meanwhile, the third electrode surface 215 is a surface that is exposed from the first side surface 126 of the main body 12 and is covered by the first side surface cover layer 30 or a surface that is exposed from the second side surface 127 of the main body 12 and is covered by the second side surface cover layer 31.

Since the third electrode surface 215 of the side electrode 21 is parallel to the first side surface 126 and/or the second side surface 127 in the multilayer inductor according to the present embodiment as described above, a sufficient magnetic path area may be secured. Furthermore, since the third electrode surface 215 comprises the same surface as the first side surface 126 and/or the second side surface 127 of the main body 12, an alignment tolerance between layers may also be reduced. Accordingly, a direct current resistance (Rdc) of the multilayer inductor may be lowered, and inductance variation may be reduced.

Unlike the present embodiment, if an outer end portion of the internal electrode has a pointed shape a magnetic path area may be reduced and an alignment tolerance between layers may occur. Thus, there are risks of frequency characteristic deterioration and inductance variation due to parasitic capacitance.

Meanwhile, a thickness D of each of the first and second side surface cover layers 30 and 31 measured along the width direction (W-axis direction) may be 10 μm or more and 30 μm or less. Here, D is measured on the basis of an optical microscope or scanning electron microscope (SEM) image of a cross-section taken in the width direction (W-axis direction)—the thickness direction (T-axis direction) at a central portion of the length direction (L-axis direction) of the multilayer inductor 100. D may be an arithmetic mean value of thicknesses of the first side surface cover layer 30, measured at 10 equally spaced points on the first side surface 126 of the multilayer inductor 100 shown in the above cross-sectional image. In addition, D may be an arithmetic mean value of thicknesses of the second side surface cover layer 31, measured at 10 equally spaced points spaced on the second side surface 127 of the multilayer inductor 100 shown in the above cross-sectional image. Other methods and/or tools appreciated by one of ordinary skill in the art, even if not described in the present disclosure, may also be used.

If the thickness D of each of the first and second side surface cover layers 30 and 31 is less than 10 μm, insufficient thickness may cause reliability degradation of the inductor. For example, the side surface cover layer may be physically destroyed during a barrel polishing process. Furthermore, if the thickness D of each of the first and second side surface cover layers 30 and 31 is less than 10 μm, there is a risk that a withstand voltage characteristics is degraded (see Table 1).

TABLE 1

| Thickness of cover layer (μm) | Insulation breakdown voltage (V) |
|---|---|
| 1 | 25 |
| 2 | 50 |
| 3 | 75 |
| 4 | 100 |
| 5 | 125 |
| 6 | 150 |
| 7 | 175 |
| 8 | 200 |
| 9 | 225 |
| 10 | 250 |
| 11 | 275 |
| 12 | 300 |
| 13 | 325 |
| 14 | 350 |
| 15 | 375 |
| 16 | 400 |
| 17 | 425 |
| 18 | 450 |
| 19 | 475 |
| 20 | 500 |
| 21 | 525 |
| 22 | 550 |
| 23 | 575 |
| 24 | 600 |
| 25 | 625 |
| 26 | 650 |
| 27 | 675 |
| 28 | 700 |
| 29 | 725 |
| 30 | 750 |

Meanwhile, if the thickness D of each of the first and second side surface cover layers 30 and 31 exceeds 30 μm, the thickness may become too thick and offset the effect of having the cover layer.

Meanwhile, the first side surface cover layer 30 may include an inner cover layer 301 and an outer cover layer 302.

The inner cover layer 301 may contact the third electrode surface 215 of the side electrode 21, and the inner cover layer 301 may be made of a material different from that of the main body 12. For example, a particle diameter of a magnetic particle included in the inner cover layer 301 may be 5% or more and 30% or less of a particle diameter of a magnetic particle included in the main body 12. In this case, the strength of the inner cover layer 301 may increase and a capacity characteristic may be improved.

The outer cover layer 302 covers the inner cover layer 301. Since the outer cover layer 302 is made of the same material as the main body 12, capacity of a portion cut off in a process of forming the third electrode surface 215 may be preserved.

The second side surface cover layer 31 may include an inner cover layer 311 and an outer cover layer 312.

The inner cover layer 311 may contact the third electrode surface 215 of the side electrode 21, and the inner cover layer 311 may be made of a material different from that of the main body 12. For example, a particle diameter of a magnetic particle included in the inner cover layer 311 may be 5% or more and 30% or less of a particle diameter of a magnetic particle included in the main body 12. In this case, strength of the inner cover layer 311 may increase and a capacity characteristic may be improved.

The particle diameter may be measured using a scanning electron microscope (SEM). Other methods and/or tools appreciated by one of ordinary skill in the art, even if not described in the present disclosure, may also be used.

The outer cover layer 312 covers the inner cover layer 311. Since the outer cover layer 312 is made of the same material as the main body 12, capacity of a portion cut off in a process of forming the third electrode surface 215 may be preserved.

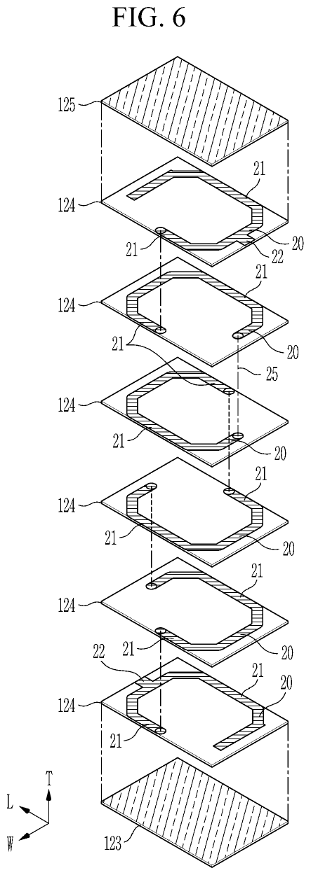

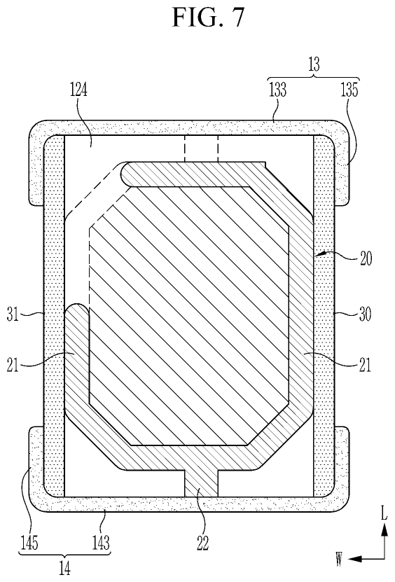

FIG. 6 is an exploded perspective view schematically illustrating the multilayer inductor shown in FIG. 3, and FIG. 7 is a plan view schematically illustrating the arrangement of the internal electrodes and the side surface cover layers of the multilayer inductor shown in FIG. 1.

Referring to FIGS. 1, 4, 6, and 7 together, the main body 12 may be formed through a firing process after a plurality of sheets 124 are stacked in the thickness direction (T-axis direction).

The sheet 124 may include a magnetic material, and may be made of magnetic particles and a thermosetting resin, such as epoxy, polyimide, or the like, interposed between the magnetic particles.

A first cover layer 123 and a second cover layer 125 may be respectively disposed outside the sheets 124 at both ends along the thickness direction (T-axis direction) within the main body 12.

That is, the first cover layer 123 having a predetermined thickness may be disposed at a lower portion of the lowermost sheet 124 within the main body 12, and the second cover layer 125 may be disposed at an upper portion of the uppermost sheet 124 within the main body 12. The first cover layer 123 and the second cover layer 125 may have the same composition as the sheet 124, and may be formed by respectively stacking one or more sheets in which the internal electrodes 20 are not formed at the lower portion of the lowermost sheet 124 of the main body 12 and at the upper portion of the uppermost sheet 124 of the main body 12.

The first and second cover layers 123 and 125 may be made of a magnetic material having ferromagnetic properties, may include, for example, a Ni—Cu—Zn-based ferrite material comprising NiO and having a molar ratio of Ni to Zn of nearly 1:1. Therefore, the first and second cover layers 123 and 125 have high permeability and high saturation magnetization.

The first and second cover layers 123 and 125 may protect the internal electrode 20 of the multilayer inductor to improve reliability and simultaneously improve a magnetic characteristic of the multilayer inductor.

The plurality of internal electrodes 20 are respectively formed on the plurality of sheets 124 and are connected to each other through a connection portion (a via) 25 to form a coil structure. A conductive paste may be printed on a surface of the sheet 124 to form the internal electrode 20.

The first and second side surface cover layers 30 and 31 may have the same composition as the sheet 124 or may have a different composition.

If the first and second side surface cover layers 30 and 31 have the same composition as the sheet 124, they may include iron (Fe), silicon (Si), carbon (C), oxygen (O), hydrogen (H), or the like. If the first and second side surface cover layers 30 and 31 have a composition different from that of the sheet 124, the sheet 124 may include iron (Fe), silicon (Si), carbon (C), oxygen (O), hydrogen (H), or the like, and the first and second side surface cover layers 30 and 31 may include carbon (C), oxygen (O), hydrogen (H), or the like. However, the present embodiment is not limited thereto, and the sheet and the side surface cover layer may be made of various materials.

In a process of manufacturing the multilayer inductor according to the present embodiment, after the internal electrodes 20 are respectively formed by printing conductive pastes on the plurality of sheets 124 and the main body 12 is formed by stacking the plurality of sheets 124 and the first and second cover layers 123 and 125, both end portions of the width direction (W-axis direction) of the main body 12 may be cut. In this process, a portion of the internal electrode 20 may also be cut together. Cut surfaces of the main body 12 may become the first and second side surfaces 126 and 127, and a cut surface of the internal electrode 20 may become the third electrode surface 215. In this case, the first side surface 126 or the second side surface 127 of the main body 12 and the third electrode surface 215 of the side electrode 21 may form the same surface.

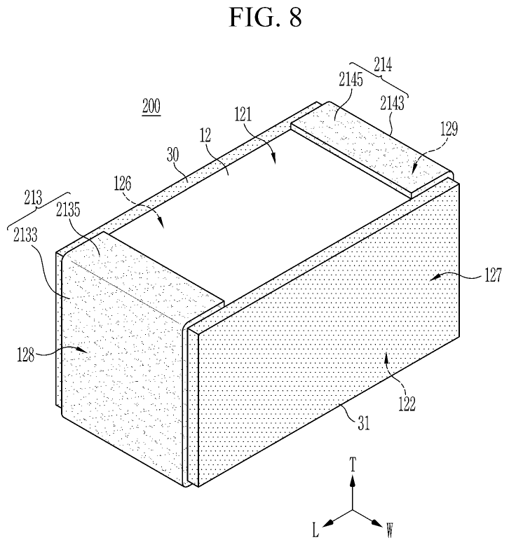

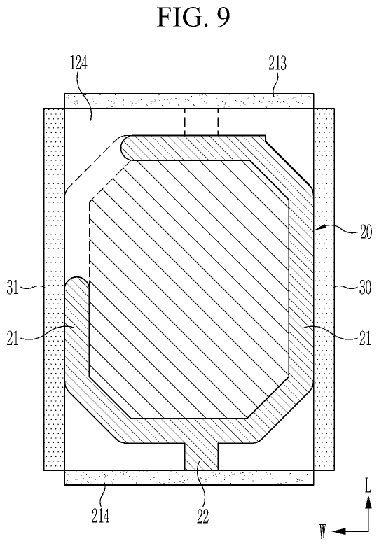

FIG. 8 is a perspective view schematically showing a multilayer inductor according to another embodiment, and FIG. 9 is a plan view schematically illustrating the arrangement of internal electrodes and side surface cover layers of the multilayer inductor shown in FIG. 8. A component of the multilayer inductor shown in FIGS. 8 and 9 that are identical to or corresponding to that of the multilayer inductor shown in FIG. 1 are denoted by the same reference numerals, and a redundant descriptions of such components will be omitted.

Referring to FIG. 8 and FIG. 9, the multilayer inductor 200 includes a main body 12, a plurality of internal electrodes 20, a first outer electrode 213 and a second outer electrode 214, a first side surface cover layer 30, and a second side surface cover layer 31.

The first outer electrode 213 may be connected to a lead portion of the internal electrode 20 on the first end surface 128 of the main body 12, and may extend to the upper surface 121.

The second outer electrode 214 may be connected to the lead portion of the internal electrode 20 on the second end surface 129 of the main body 12, and may extend to the upper surface 121.

For example, the first and second outer electrodes 213 and 214 are disposed at both end portions of the length direction (L-axis direction) of the main body 12. The first outer electrode 213 may include a first end portion 2133 and a first band portion 2135, and the second outer electrode 214 may include a second end portion 2143 and a second band portion 2145.

The first end portion 2133 covers the first end surface 128 of the main body 12, and is electrically connected to the lead portion of the internal electrode 20.

The second end portion 2143 covers the second end surface 129 of the main body 12, and is electrically connected to the lead portion of the internal electrode 20.

The first band portion 2135 may extend from the first end portion 2133 along the length direction (L-axis direction), and may cover a portion of the upper surface 121 of the main body 12.

The second band portion 2145 may extend from the second end portion 2143 along the length direction (L-axis direction), and may cover a portion of the upper surface 121 of the main body 12.

As described above, the outer electrodes 213 and 214 do not extend to the first side surface 126 and the second side surface 127 of the main body 12. Therefore, the first side surface 126 of the main body 12 is entirely covered by the first side surface cover layer 30, and the second side surface 127 is entirely covered by the second side surface cover layer 31. Regions at both end portions of the first side surface cover layer 30 along the length direction (L-axis direction) may contact the first end portion 2133 and the first band portion 2135, and regions at both end portions of the second side surface cover layer 31 along the length direction (L-axis direction) may contact the second end portion 2143 and the second band portion 2145.

Since the shape of the side electrode 21 in the present embodiment is the same as that of the side electrode of the multilayer inductor shown in FIG. 1, the same or similar effect is obtained.

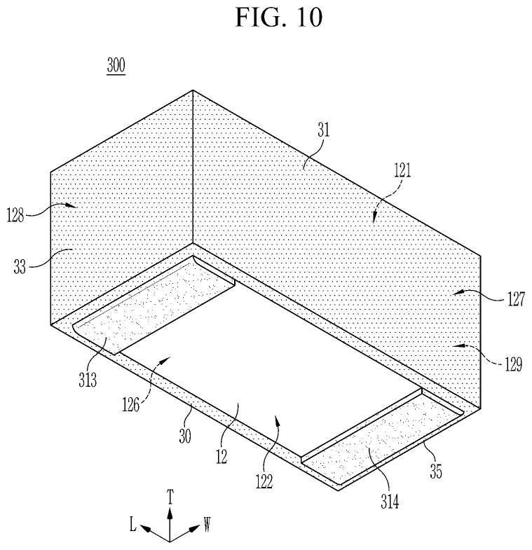

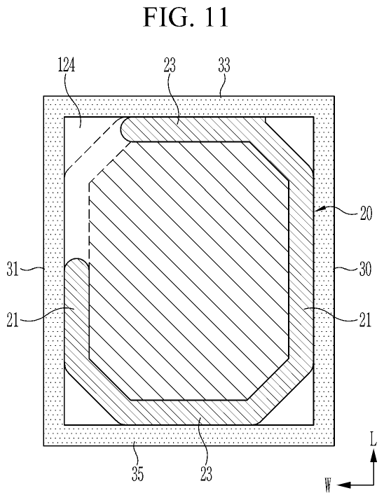

FIG. 10 is a perspective view schematically showing a multilayer inductor according to another embodiment, and FIG. 11 is a plan view schematically illustrating the arrangement of internal electrodes and side surface cover layers of the multilayer inductor shown in FIG. 10. Components of the multilayer shown in FIGS. 10 and 11, that are identical to or correspond to that of the multilayer inductor shown in FIG. 1 are denoted by the same reference numerals, and redundant descriptions of such components will be omitted.

Referring to FIG. 10 and FIG. 11, the multilayer inductor 300 includes a main body 12, a plurality of internal electrodes 20, a first outer electrode 313, a second outer electrode 314, a first side surface cover layer 30, a second side surface cover layer 31, a first end portion cover layer 33, and a second end portion cover layer 35.

The first and second outer electrodes 313 and 314 are disposed on a surface (that is, the lower surface 122) (T-axis direction) of the main body 12 in the thickness direction, and respectively cover portions of both end portions of the lower surface 122 along the length direction (L-axis direction).

The first outer electrode 313 is a portion electrically connected to one end of the internal electrode 20, and the second outer electrode 314 is a portion electrically connected to the other end of the internal electrode 20.

Since the first and second outer electrodes 313 and 314 are disposed only a portion of the lower surface 122 of the main body 12, the first and second outer electrodes 313 and 314 are not disposed at the first end surface 128, the second end surface 129, the first side surface 126, and the second side surface 127 of the main body 12. Therefore, the first side surface 126 of the main body 12 is entirely covered by the first side surface cover layer 30, and the second side surface 127 is entirely covered by the second side surface cover layer 31. Further, the first end surface 128 of the main body 12 is entirely covered by the first end portion cover layer 33, and the second end surface 129 is entirely covered by the second end portion cover layer 35.

The internal electrode 20 includes a side electrode 21 and an end electrode (or an end portion electrode) 23.

The side electrode 21 is exposed from the first side surface 126 of the main body 12, and the side electrode 21 is exposed from the second side surface 127 of the main body 12. For example, the side electrode 21 may contact the first side surface 126 or may comprise the same surface as the first side surface 126, and the side electrode 21 may contact the second side surface 127 or may comprise the same surface as the second side surface 127.

The end electrode 23 is exposed from the first end surface 128 of the main body 12, and the end electrode 23 is exposed from the second end surface 129 of the main body 12. For example, the end electrode 23 may contact the first end surface 128 or may comprise the same surface as the first end surface 128, and the end electrode 23 may contact the second end surface 129 or may comprise the same surface as the second end surface 129.

One end of the end electrode 23 may be electrically connected to the outer electrode 313 or 314, and this connection may be made in various known ways. For example, the lead portion may extend from the end electrode 23 along the thickness direction (T-axis direction) of the main body 12 to be connected to the outer electrode 313 or 314.

Since a shape of the side electrode 21 in the present embodiment is the same as that of the side electrode of the multilayer inductor shown in FIG. 1, the same or similar effect is obtained.

Hereinafter, specific embodiments of the present disclosure are presented. However, embodiments described below are only intended to specifically illustrate or explain the disclosure, and the scope of the disclosure should not be limited thereto.

### Manufacturing Example: Manufacturing of Coil Electronic Component

### Embodiment 1

A coil electronic component in which a ratio of the second thickness T2 of the third electrode surface to the first thickness T1 of the side electrode of the coil electronic component is 0.03, is manufactured.

### Embodiment 2

Example 2 is the same as Example 1 except that the ratio of the second thickness T2 of the third electrode surface to the first thickness T1 of the side electrode of the coil electronic component is 0.05.

### Embodiment 3

Example 3 is the same as Example 1 except that the ratio of the second thickness T2 of the third electrode surface to the first thickness T1 of the side electrode of the coil electronic component is 0.08.

### Embodiment 4

Example 4 is the same as Example 1 except that the ratio of the second thickness T2 of the third electrode surface to the first thickness T1 of the side electrode of the coil electronic component is 0.10.

### Embodiment 5

Example 5 is the same as Example 1 except that the ratio of the second thickness T2 of the third electrode surface to the first thickness T1 of the side electrode of the coil electronic component is 0.13.

### Embodiment 6

Example 6 is the same as Example 1 except that the ratio of the second thickness T2 of the third electrode surface to the first thickness T1 of the side electrode of the coil electronic component is 0.15.

### Embodiment 7

Example 7 is the same as Example 1 except that the ratio of the second thickness T2 of the third electrode surface to the first thickness T1 of the side electrode of the coil electronic component is 0.18.

### Embodiment 8

Example 8 is the same as Example 1 except that the ratio of the second thickness T2 of the third electrode surface to the first thickness T1 of the side electrode of the coil electronic component is 0.20.

### Embodiment 9

Example 9 is the same as Example 1 except that the ratio of the second thickness T2 of the third electrode surface to the first thickness T1 of the side electrode of the coil electronic component is 0.23.

### Embodiment 10

Example 10 is the same as Example 1 except that the ratio of the second thickness T2 of the third electrode surface to the first thickness T1 of the side electrode of the coil electronic component is 0.25.

### Embodiment 11

Example 11 is the same as Example 1 except that the ratio of the second thickness T2 of the third electrode surface to the first thickness T1 of the side electrode of the coil electronic component is 0.28.

### Embodiment 12

Example 12 is the same as Example 1 except that the ratio of the second thickness T2 of the third electrode surface to the first thickness T1 of the side electrode of the coil electronic component is 0.30.

### Embodiment 13

Example 13 is the same as Example 1 except that the ratio of the second thickness T2 of the third electrode surface to the first thickness T1 of the side electrode of the coil electronic component is 0.33.

### Embodiment 14

Example 14 is the same as Example 1 except that the ratio of the second thickness T2 of the third electrode surface to the first thickness T1 of the side electrode of the coil electronic component is 0.35.

### Embodiment 15

Example 15 is the same as Example 1 except that the ratio of the second thickness T2 of the third electrode surface to the first thickness T1 of the side electrode of the coil electronic component is 0.38.

### Embodiment 16

Example 16 is the same as Example 1 except that the ratio of the second thickness T2 of the third electrode surface to the first thickness T1 of the side electrode of the coil electronic component is 0.40.

### Embodiment 17

Example 17 is the same as Example 1 except that the ratio of the second thickness T2 of the third electrode surface to the first thickness T1 of the side electrode of the coil electronic component is 0.43.

### Embodiment 18

Example 18 is the same as Example 1 except that the ratio of the second thickness T2 of the third electrode surface to the first thickness T1 of the side electrode of the coil electronic component is 0.45.

### Embodiment 19

Example 19 is the same as Example 1 except that the ratio of the second thickness T2 of the third electrode surface to the first thickness T1 of the side electrode of the coil electronic component is 0.48.

### Embodiment 20

Example 20 is the same as Example 1 except that the ratio of the second thickness T2 of the third electrode surface to the first thickness T1 of the side electrode of the coil electronic component is 0.50.

### Embodiment 21

Example 21 is the same as Example 1 except that the ratio of the second thickness T2 of the third electrode surface to the first thickness T1 of the side electrode of the coil electronic component is 0.53.

### Embodiment 22

Example 22 is the same as Example 1 except that the ratio of the second thickness T2 of the third electrode surface to the first thickness T1 of the side electrode of the coil electronic component is 0.55.

### Embodiment 23

Example 23 is the same as Example 1 except that the ratio of the second thickness T2 of the third electrode surface to the first thickness T1 of the side electrode of the coil electronic component is 0.58.

### Embodiment 24

Example 24 is the same as Example 1 except that the ratio of the second thickness T2 of the third electrode surface to the first thickness T1 of the side electrode of the coil electronic component is 0.60.

### Embodiment 25

Example 25 is the same as Example 1 except that the ratio of the second thickness T2 of the third electrode surface to the first thickness T1 of the side electrode of the coil electronic component is 0.63.

### Embodiment 26

Example 26 is the same as Example 1 except that the ratio of the second thickness T2 of the third electrode surface to the first thickness T1 of the side electrode of the coil electronic component is 0.65.

### Embodiment 27

Example 27 is the same as Example 1 except that the ratio of the second thickness T2 of the third electrode surface to the first thickness T1 of the side electrode of the coil electronic component is 0.68.

### Embodiment 28

Example 28 is the same as Example 1 except that the ratio of the second thickness T2 of the third electrode surface to the first thickness T1 of the side electrode of the coil electronic component is 0.70.

### Embodiment 29

Example 29 is the same as Example 1 except that the ratio of the second thickness T2 of the third electrode surface to the first thickness T1 of the side electrode of the coil electronic component is 0.73.

### Embodiment 30

Example 30 is the same as Example 1 except that the ratio of the second thickness T2 of the third electrode surface to the first thickness T1 of the side electrode of the coil electronic component is 0.75.

### Comparative Example 1

Comparative Example 1 is the same as Example 1 except that the ratio of the second thickness T2 of the third electrode surface to the first thickness T1 of the side electrode of the coil electronic component is 0.78.

### Comparative Example 2

Comparative Example 2 is the same as Example 1 except that the ratio of the second thickness T2 of the third electrode surface to the first thickness T1 of the side electrode of the coil electronic component is 0.80.

### Comparative Example 3

Comparative Example 3 is the same as Example 1 except that the ratio of the second thickness T2 of the third electrode surface to the first thickness T1 of the side electrode of the coil electronic component is 0.83.

### Comparative Example 4

Comparative Example 4 is the same as Example 1 except that the ratio of the second thickness T2 of the third electrode surface to the first thickness T1 of the side electrode of the coil electronic component is 0.85.

### Comparative Example 5

Comparative Example 5 is the same as Example 1 except that the ratio of the second thickness T2 of the third electrode surface to the first thickness T1 of the side electrode of the coil electronic component is 0.88.

### Comparative Example 6

Comparative Example 6 is the same as Example 1 except that the ratio of the second thickness T2 of the third electrode surface to the first thickness T1 of the side electrode of the coil electronic component is 0.90.

### Comparative Example 7

Comparative Example 7 is the same as Example 1 except that the ratio of the second thickness T2 of the third electrode surface to the first thickness T1 of the side electrode of the coil electronic component is 0.93.

### Comparative Example 8

Comparative Example 8 is the same as Example 1 except that the ratio of the second thickness T2 of the third electrode surface to the first thickness T1 of the side electrode of the coil electronic component is 0.95.

### Comparative Example 9

Comparative Example 9 is the same as Example 1 except that the ratio of the second thickness T2 of the third electrode surface to the first thickness T1 of the side electrode of the coil electronic component is 0.98.

### Experimental Example: Capacity Loss of Coil Electronic Component

After 30 pieces of coil electronic components of Embodiments 1-30 and 30 pieces of coil electronic components of Comparative Examples 1-9 are manufactured, the ratio of the second thickness T2 of the third electrode surface to the first thickness T1 of the side electrode of the coil electronic component is measured, and after it is confirmed whether capacity losses of the coil electronic components are within an allowable range (e.g., 0 to 10%), the result is summarized in Table 2.

TABLE 2

| | | | | Capacity | |
|---|---|---|---|---|---|
| | T1 (μm) | T2 (μm) | T1/T2 | Loss (%) | Result |
| Embodiment 1 | 40 | 1 | 0.03 | 0.2% | Good |
| Embodiment 2 | 40 | 2 | 0.05 | 0.6% | Good |
| Embodiment 3 | 40 | 3 | 0.08 | 0.9% | Good |
| Embodiment 4 | 40 | 4 | 0.10 | 1.2% | Good |
| Embodiment 5 | 40 | 5 | 0.13 | 1.6% | Good |
| Embodiment 6 | 40 | 6 | 0.15 | 1.9% | Good |
| Embodiment 7 | 40 | 7 | 0.18 | 2.2% | Good |
| Embodiment 8 | 40 | 8 | 0.20 | 2.5% | Good |
| Embodiment 9 | 40 | 9 | 0.23 | 2.9% | Good |
| Embodiment 10 | 40 | 10 | 0.25 | 3.2% | Good |
| Embodiment 11 | 40 | 11 | 0.28 | 3.5% | Good |
| Embodiment 12 | 40 | 12 | 0.30 | 3.9% | Good |
| Embodiment 13 | 40 | 13 | 0.33 | 4.2% | Good |
| Embodiment 14 | 40 | 14 | 0.35 | 4.5% | Good |
| Embodiment 15 | 40 | 15 | 0.38 | 4.9% | Good |
| Embodiment 16 | 40 | 16 | 0.40 | 5.2% | Good |
| Embodiment 17 | 40 | 17 | 0.43 | 5.5% | Good |
| Embodiment 18 | 40 | 18 | 0.45 | 5.8% | Good |
| Embodiment 19 | 40 | 19 | 0.48 | 6.2% | Good |
| Embodiment 20 | 40 | 20 | 0.50 | 6.5% | Good |
| Embodiment 21 | 40 | 21 | 0.53 | 6.8% | Good |
| Embodiment 22 | 40 | 22 | 0.55 | 7.2% | Good |
| Embodiment 23 | 40 | 23 | 0.58 | 7.5% | Good |
| Embodiment 24 | 40 | 24 | 0.60 | 7.8% | Good |
| Embodiment 25 | 40 | 25 | 0.63 | 8.2% | Good |
| Embodiment 26 | 40 | 26 | 0.65 | 8.5% | Good |
| Embodiment 27 | 40 | 27 | 0.68 | 8.8% | Good |
| Embodiment 28 | 40 | 28 | 0.70 | 9.1% | Good |
| Embodiment 29 | 40 | 29 | 0.73 | 9.5% | Good |
| Embodiment 30 | 40 | 30 | 0.75 | 9.8% | Good |
| Comparative | 40 | 31 | 0.78 | 10.1% | High |
| Example 1 | | | | | |
| Comparative | 40 | 32 | 0.80 | 10.5% | High |
| Example 2 | | | | | |
| Comparative | 40 | 33 | 0.83 | 10.8% | High |
| Example 3 | | | | | |
| Comparative | 40 | 34 | 0.85 | 11.1% | High |
| Example 4 | | | | | |
| Comparative | 40 | 35 | 0.88 | 11.5% | High |
| Example 5 | | | | | |
| Comparative | 40 | 36 | 0.90 | 11.8% | High |
| Example 6 | | | | | |
| Comparative | 40 | 37 | 0.93 | 12.1% | High |
| Example 7 | | | | | |
| Comparative | 40 | 38 | 0.95 | 12.4% | High |
| Example 8 | | | | | |
| Comparative | 40 | 39 | 0.98 | 12.8% | High |
| Example 9 | | | | | |

Referring to Table 2, it may be seen that each of the coil electronic components manufactured in Embodiments 1-30 has a capacity loss of less than 10%, which is within the allowable range. On the other hand, it may be seen that each of the coil electronic components manufactured in Comparative Examples 1-9 has a capacity loss of more than 10%, which is out of the allowable range. This is because increasing the thickness of the third electrode surface requires increasing the volume of magnetic material that is cut during manufacturing, which can lead to volume loss, which in turn can lead to capacity loss.

### Experimental Example: DC Resistance (Rdc) of Coil Electronic Component

After 30 pieces of coil electronic components of Embodiments 1-30 and 30 pieces of coil electronic components of Comparative Examples 1-9 are manufactured, the ratio of the second thickness T2 of the third electrode surface to the first thickness T1 of the side electrode of the coil electronic component is measured, and after it is confirmed whether a direct current resistance (Rdc) of the coil electronic component is within an allowable range (e.g., 76 mΩ or less), the result is summarized in Table 3.

TABLE 3

| | T1 (μm) | T2 (μm) | T1/T2 | Rdc (mΩ) | Result |
|---|---|---|---|---|---|
| Embodiment 1 | 40 | 1 | 0.03 | 64 | Good |
| Embodiment 2 | 40 | 2 | 0.05 | 65 | Good |
| Embodiment 3 | 40 | 3 | 0.08 | 65 | Good |
| Embodiment 4 | 40 | 4 | 0.10 | 66 | Good |
| Embodiment 5 | 40 | 5 | 0.13 | 66 | Good |
| Embodiment 6 | 40 | 6 | 0.15 | 67 | Good |
| Embodiment 7 | 40 | 7 | 0.18 | 68 | Good |
| Embodiment 8 | 40 | 8 | 0.20 | 68 | Good |
| Embodiment 9 | 40 | 9 | 0.23 | 69 | Good |
| Embodiment 10 | 40 | 10 | 0.25 | 70 | Good |
| Embodiment 11 | 40 | 11 | 0.28 | 70 | Good |
| Embodiment 12 | 40 | 12 | 0.30 | 71 | Good |
| Embodiment 13 | 40 | 13 | 0.33 | 72 | Good |
| Embodiment 14 | 40 | 14 | 0.35 | 72 | Good |
| Embodiment 15 | 40 | 15 | 0.38 | 73 | Good |
| Embodiment 16 | 40 | 16 | 0.40 | 74 | Good |
| Embodiment 17 | 40 | 17 | 0.43 | 75 | Good |
| Embodiment 18 | 40 | 18 | 0.45 | 75 | Good |
| Embodiment 19 | 40 | 19 | 0.48 | 76 | Good |
| Embodiment 20 | 40 | 20 | 0.50 | 77 | High |
| Embodiment 21 | 40 | 21 | 0.53 | 78 | High |
| Embodiment 22 | 40 | 22 | 0.55 | 79 | High |
| Embodiment 23 | 40 | 23 | 0.58 | 79 | High |
| Embodiment 24 | 40 | 24 | 0.60 | 80 | High |
| Embodiment 25 | 40 | 25 | 0.63 | 81 | High |
| Embodiment 26 | 40 | 26 | 0.65 | 82 | High |
| Embodiment 27 | 40 | 27 | 0.68 | 83 | High |
| Embodiment 28 | 40 | 28 | 0.70 | 84 | High |
| Embodiment 29 | 40 | 29 | 0.73 | 85 | High |
| Embodiment 30 | 40 | 30 | 0.75 | 86 | High |
| Comparative | 40 | 31 | 0.78 | 87 | High |
| Example 1 | | | | | |
| Comparative | 40 | 32 | 0.80 | 88 | High |
| Example 2 | | | | | |
| Comparative | 40 | 33 | 0.83 | 89 | High |
| Example 3 | | | | | |
| Comparative | 40 | 34 | 0.85 | 90 | High |
| Example 4 | | | | | |
| Comparative | 40 | 35 | 0.88 | 92 | High |
| Example 5 | | | | | |
| Comparative | 40 | 36 | 0.90 | 93 | High |
| Example 6 | | | | | |
| Comparative | 40 | 37 | 0.93 | 94 | High |
| Example 7 | | | | | |
| Comparative | 40 | 38 | 0.95 | 95 | High |
| Example 8 | | | | | |
| Comparative | 40 | 39 | 0.98 | 96 | High |
| Example 9 | | | | | |

Referring to Table 3, it may be seen that each of the coil electronic components manufactured in Embodiments 1-19 has a DC resistance of 76 mΩ or less, which is within the allowable range. On the other hand, it may be seen that each of the coil electronic components manufactured in Embodiments 20-30 and Comparative Example 1-9 has a direct current resistance more than 76 mΩ, which is out of the allowable range. This is because increasing the thickness of the third electrode surface also increases the volume of the side electrodes, or coils, that are cut during manufacturing, which can lead to increased direct current resistance.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer inductor comprising:
a main body including a magnetic material, the main body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface;
a plurality of internal electrodes disposed inside the main body;
an outer electrode disposed outside the main body; and
side surface cover layers that respectively covers the third surface and the fourth surface,
wherein at least one internal electrode among the plurality of internal electrodes includes a first electrode surface and a second electrode surface facing each other in the third direction and a third electrode surface connecting the first electrode surface and the second electrode surface and substantially parallel to the third surface, the fourth surface, or both, and the third electrode surface contacts the side surface cover layers.

2. The multilayer inductor of claim 1, wherein the at least one internal electrode includes two edges opposing each other in the second direction, and the two edges include (i) one edge comprising the third electrode surface, and (ii) an other edge.

3. The multilayer inductor of claim 2, wherein the at least one internal electrode has a tapered shape toward the one edge.

4. The multilayer inductor of claim 2, wherein the first electrode surface and the second electrode surface meet to make an acute angle at the other edge.

5. The multilayer inductor of claim 4, wherein the at least one internal electrode has a tapered shape toward the other edge.

6. The multilayer inductor of claim 2, wherein the at least one internal electrode has a width that is a distance between the two edges, and a first thickness that is an average value of distances between the first electrode surface and the second electrode surface measured over a range corresponding to 60% of the width, the third electrode surface has a second thickness along the third direction, and a ratio of the second thickness to the first thickness is greater than 0 and less than or equal to 1.

7. The multilayer inductor of claim 6, wherein a ratio of the second thickness to the first thickness is greater than 0 and less than or equal to 0.75.

8. The multilayer inductor of claim 6, wherein a ratio of the second thickness to the first thickness is greater than 0 and less than or equal to 0.48.

9. The multilayer inductor of claim 3, wherein the third electrode surface is flush with the third surface or is flush with the fourth surface.

10. The multilayer inductor of claim 1, wherein in a cross-section perpendicular to the first direction, a thickness of each of the side surface cover layers along the second direction is 10 μm or more and 30 μm or less.

11. The multilayer inductor of claim 1, wherein the main body and each of the side surface cover layers include the same material.

12. The multilayer inductor of claim 1, wherein the main body and each of the side surface cover layers include different materials.

13. The multilayer inductor of claim 1, wherein each of the side surface cover layers includes a first cover layer that is in contact with the third electrode surface and a second cover layer that covers the first cover layer,
the first cover layer includes a material different from that of the main body, and the second cover layer includes the same material as the main body.

14. The multilayer inductor of claim 13, wherein the first cover layer includes a first magnetic particle, the main body includes a second magnetic particle, and a particle diameter of the first magnetic particle is 5% or more and 30% or less of a particle diameter of the second magnetic particle.

15. The multilayer inductor of claim 1, wherein the outer electrode is connected to the plurality of internal electrodes on the first surface and/or the second surface, extends to the fifth surface and the sixth surface, and covers two edges of each of the side surface cover layers facing each other in the first direction.

16. The multilayer inductor of claim 1, wherein the outer electrode is connected to the plurality of internal electrodes on the first surface and/or the second surface and extends to the fifth surface and the sixth surface, and each of the side surface cover layers contacts the outer electrode (i) at a boundary between the third surface and the first surface, the second surface, the fifth surface, and the sixth surface and (ii) at a boundary between the fourth surface and the first surface, the second surface, the fifth surface, and the sixth surface.

17. The multilayer inductor of claim 1, wherein the outer electrode is connected to the plurality of internal electrodes on the fifth surface or the sixth surface, the outer electrode covers a portion of the fifth surface or the sixth surface, and each of the side surface cover layers covers the first surface, the second surface, the third surface, and the fourth surface.

18. A multilayer inductor comprising:
a main body including a magnetic material, the main body including a first surface and a second surface facing each other in a first direction, a third surface and a fourth surface facing each other in a second direction and connecting the first surface and the second surface, and a fifth surface and a sixth surface facing each other in a third direction and connecting the first surface and the second surface;
a plurality of internal electrodes disposed inside the main body;
an outer electrode disposed outside the main body; and
side surface cover layers that respectively covers the third surface and the fourth surface,
wherein at least one internal electrode among the plurality of internal electrodes includes a first electrode surface and a second electrode surface facing each other in the third direction and a third electrode surface connecting the first electrode surface and the second electrode surface and substantially parallel to the third surface, the fourth surface, or both, and the third electrode surface contacts the side surface cover layers, and
wherein the at least one internal electrode includes two edges opposing each other in the second direction, and the at least one internal electrode has a shape that tapers toward each of the two edges.

19. The multilayer inductor of claim 18, wherein in a cross-section perpendicular to the first direction, a thickness of each of the side surface cover layers along the second direction is 10 μm or more and 30 μm or less.

20. The multilayer inductor of claim 19, wherein the at least one internal electrode has a width that is a distance between the two edges, and a first thickness that is an average value of distances between the first electrode surface and the second electrode surface measured over a range corresponding to 60% of the width, the third electrode surface has a second thickness along the third direction, and a ratio of the second thickness to the first thickness is greater than 0 and less than 1.
